(19) United States
(12) Patent Application Publication
(10) Pub. No.: US 2006/0226578 A1
(43) Pub. Date: Oct. 12, 2006

(54) Processes for facilitating removel of fabricated objects from platens of programmed material consolidation equipment, and fabrication processes employing the object release elements

(76) Inventors: Warren M. Farnworth, Nampa, ID (US); Kevin G. Duesman, Boise, ID (US)

Correspondence Address: TRASK BRITT, P.O. BOX 2550, SALT LAKE CITY, UT, 84110, US

(21) Appl. No.: 11/450,742

(22) Filed: Jun. 9, 2006

Related U.S. Application Data
(62) Division of application No. 10/663,402, filed on Sep. 16, 2003.

(51) Int. Cl. B29C 35/08; B29C 41/02; B29C 33/68

(52) U.S. Cl. 264/401; 264/308; 264/338

(57) ABSTRACT

A programmed material consolidation method includes use of an object release element for facilitate removal of an object from a platen of programmed material consolation equipment while leaving substantially no residue on the platen or a fabricated object, and without requiring substantial post-release modification of the fabricated object. The object release element may be adhesively secured to a non-stick surface of the platen, with a material that adheres to the platen before being cured and that may be removed from the platen upon curing, or by application of a negative pressure through the platen to the object release element. The object release element may be formed from a material or include coating of a material, such as polyethylene, polyethyleneteraphthalate, or polyethylene ethyl ketone, that adheres to a fabricated object, but may be readily released from the fabricated object (e.g., by peeling).

### CROSS-REFERENCE TO RELATED APPLICATION

This application is a divisional of application Ser. No. 10/663,402, filed Sep. 16, 2003, pending.

### BACKGROUND OF THE INVENTION

1. Field of the Invention

The present invention relates generally to processes for facilitating the removal of stereolithographically fabricated objects from platens on or over which they are formed and, more specifically, to processes that facilitate the removal of stereolithographically fabricated objects without requiring the use of the material or materials used in fabricating such objects. In particular, the present invention relates to processes which employ an object release element upon which an object may be stereolithographically fabricated and which may subsequently be readily removed from a platen of stereolithographic fabrication equipment and from the stereolithographically fabricated object.

2. Background of Related Art

“Stereolithography” is a manufacturing process that is employed in many industries. Stereolithography, which is also known as “layered manufacturing,” essentially involves the use of a computer to generate a three-dimensional (3-D) mathematical simulation or model of an object to be fabricated. Such a simulation or model is usually generated and manipulated with 3-D computer-aided design (CAD) software. The simulation or model is mathematically separated or “sliced” into a large number of relatively thin, parallel, usually vertically superimposed layers, each layer having defined boundaries and other features associated with the simulation or model and, thus, the actual object to be fabricated at the level of that layer within the exterior boundaries of the object. A complete assembly or stack of all of the layers defines the entire object, and surface resolution of the object is, in part, dependent upon the thicknesses of the layers.

The simulation or model is then employed to generate an actual object by building the object, layer by superimposed layer. A wide variety of approaches to stereolithography by different companies has resulted in techniques for fabrication of objects from a variety of materials. As shown in FIG. 1, many stereolithographic fabrication techniques involve the disposition of a layer 4′ of unconsolidated or unfixed material 3 corresponding to each layer of the simulation or model and, thus, of an object 5 to be fabricated. Next, unconsolidated or unfixed material 3 at and within at least portions of the boundaries of that layer 4′ of object 5 is selectively consolidated or fixed to an at least a partially consolidated, or semisolid, state. At the same time, material 3 of a layer 4′ under fabrication may be adhered or bonded to a next-lower layer 4 of object 5.

Depending upon the type of stereolithographic technique being employed, as well as the stereolithographic fabrication equipment used to effect the technique, the unconsolidated or unfixed material 3 employed to build object 5 may be supplied in particulate or liquid form, and unconsolidated or unfixed material 3 may itself be consolidated or fixed, or a separate binder material may be employed to bond material particles to one another and to those of a previously formed layer.

When particulate materials are employed, resolution of object surfaces is highly dependent upon particle size, whereas when a liquid is employed, surface resolution is highly dependent upon the minimum surface area of the liquid which can be fixed and the minimum thickness of a layer that can be generated. Of course, in either case, resolution and accuracy of object reproduction from the CAD file is also dependent upon the ability of the apparatus used to fix the material to precisely track the mathematical instructions indicating solid areas and boundaries for each layer of material. Toward that end, and depending upon the layer being fixed, various fixation approaches have been employed, including particle bombardment (electron beams), disposing a binder or other fixative (such as by ink-jet printing techniques), or irradiation using heat or specific wavelength ranges.

The latter irradiation approach may be effected with the SLA-250/50HR, SLA-5000, and SLA-7000 stereolithography systems that are offered by 3D Systems, Inc., of Valencia, Calif., using ultraviolet-curable polymers, or “photopolymers,” such as CIBATOOL SL 5170 and SL 5210 resins (for the SLA-250/50HR system), CIBATOOL SL 5530 resin (for the SLA-5000 and SLA-7000 systems), and CIBATOOL SL 7510 resin (for the SLA-7000 system), each of which is available from Ciba Specialty Chemicals Company. Examples of the processes that may be used in performing these techniques are described in various United States Patents that have been assigned to 3D Systems, including, without limitation, U.S. Pat. Nos. 4,575,330; 4,929,402; 4,996,010; 4,999,143; 5,015,424; 5,058,988; 5,059,021; 5,059,359; 5,071,337; 5,076,974; 5,096,530; 5,104,592; 5,123,734; 5,130,064; 5,133,987; 5,141,680; 5,143,663; 5,164,128; 5,174,931; 5,174,943; 5,182,055; 5,182,056; 5,182,715; 5,184,307; 5,192,469; 5,192,559; 5,209,878; 5,234,636; 5,236,637; 5,238,639; 5,248,456; 5,256,340; 5,258,146; 5,267,013; 5,273,691; 5,321,622; 5,344,298; 5,345,391; 5,358,673; 5,447,822; 5,481,470; 5,495,328; 5,501,824; 5,554,336; 5,556,590; 5,569,349; 5,569,431; 5,571,471; 5,573,722; 5,609,812; 5,609,813; 5,610,824; 5,630,981; 5,637,169; 5,651,934; 5,667,820; 5,672,312; 5,676,904; 5,688,464; 5,693,144; 5,695,707; 5,711,911; 5,776,409; 5,779,967; 5,814,265; 5,850,239; 5,854,748; 5,855,718; 5,855,836; 5,885,511; 5,897,825; 5,902,537; 5,902,538; 5,904,889; 5,943,235; and 5,945,058. The disclosure of each of the foregoing patents is hereby incorporated herein in its entirety by this reference.

When ultraviolet-curing stereolithographic techniques are used to fabricate objects, the objects are formed directly on a support surface of a platen, or tray, of a stereolithographic fabrication apparatus. When cured, the ultraviolet-curable materials that are usually used in such processes typically adhere to the platen. Thus, an object which has been stereolithographically fabricated from ultraviolet-curable materials is typically removed from the platen on which it was formed by way of mechanical removal processes.

In order to facilitate removal of a stereolithographically fabricated object from a platen 112 and reduce damage to a stereolithographically fabricated object 5 during the removal process, and as shown in FIG. 2, substructures, such as extremely fine columns, or “hairs” 6, may be stereolithographically fabricated on a support surface 114 of platen 112 prior to stereolithographic fabrication of object 5 thereon. After hairs 6 have been fabricated to a desired height, a mesa-like structure 7 is formed thereover. The desired object 5 is then formed, layer by superimposed layer, in accordance with programming of a stereolithographic system controller, such as a computer. The system controller controls the depth the platen is lowered into a bath of ultraviolet-curable polymer, as well as the locations of a layer of such polymer that are to be exposed to ultraviolet radiation, which is typically embodied as a laser beam.

Once the desired object has been fabricated, the hairs may be cut. The portions of hairs 6 that remain on the fabricated object 5 may also be removed therefrom, such as by sanding, as may the mesa-like structure 7.

Although this practice has found widespread use in ultraviolet-curing stereolithography techniques, it remains somewhat undesirable due to the amount of expensive, ultraviolet-curable polymer that is required just for forming the hairs. Also, the amount of equipment time that is needed to fabricate the hairs is significant and could be put to better use in fabricating the finished product. Further, a significant amount of time is required to finish the bottom surface of each fabricated object by removing the remainders of any hairs therefrom and, possibly, the mesa-like structures that were formed above the hairs.

Accordingly, there is a need for a process and element to facilitate the release of objects from the platens of stereolithographic fabrication equipment without consuming excess stereolithographic fabrication material and without requiring additional finishing of the stereolithographically fabricated object.

### SUMMARY OF THE INVENTION

The present invention, in one embodiment, includes a process for facilitating the removal of stereolithographically fabricated objects from the platens on or over which they are formed. Processes for forming object release elements in accordance with teachings of the present invention do not require the use of the same material or materials that are to be used to stereolithographically fabricate one or more objects that will have to be removed from the platen of a stereolithographic fabrication apparatus.

As an example of a process according to the present invention, an object release element that may subsequently be readily removed from a platen of stereolithographic fabrication equipment and from the stereolithographically fabricated object may be used. Initially, the object release element is secured to a platen of stereolithographic fabrication equipment. An object is then fabricated, using stereolithographic fabrication techniques, directly on the object release element. Once the object has been fabricated, the object release element may be removed from both the platen and the stereolithographically fabricated object.

An object release element that is useful in a process according to the present invention and, thus, which incorporates teachings of the present invention, comprises a substrate which includes an upper surface and a lower surface. The upper surface of the substrate, which is configured to have one or more objects stereolithographically fabricated thereon, may remain exposed when the object release element is secured to a platen. The material from which the substrate is formed, or from which a layer on the upper surface of the substrate is formed, may temporarily adhere to a stereolithographically fabricated object thereon, but readily release, or peel, from the stereolithographically fabricated structure when such removal is desired, such as when the object release element is pulled away from a fabricated object with sufficient force.

The lower surface of the substrate may be coated with a material, such as a suitable adhesive, which facilitates adhesion of the object release element to a platen of stereolithographic fabrication equipment, as well as removal of the object release element from the platen. By way of example only, a polymer, such as an ultraviolet-curable adhesive, that adheres to the material (e.g., stainless steel, quartz, etc.) of the platen when in an uncured state, but has reduced adhesion to the material of the platen when in a cured state, may be used. Alternatively, the lower surface of the substrate of the object release element may be coated with a suitable pressure sensitive adhesive. As yet another example, the lower surface of the substrate of an object release element incorporating teachings of the present invention may be configured to seal against a platen of a stereolithographic fabrication apparatus when a negative pressure (e.g., a vacuum) is applied thereto through the platen (e.g., lower surface may be substantially planar, comprise a somewhat conformable material, etc.).

Thus, the present invention also includes stereolithographic fabrication apparatus with platens that are configured to communicate a negative pressure to support surfaces thereof.

Object release elements and processes that incorporate teachings of the present invention may be used to stereolithographically fabricate any type of object, including, but not limited to, so-called “rapid prototypes” and mass-produced structures, such as components that are to be used with semiconductor devices, or “semiconductor device components.” By way of example only, stereolithographic processes may be used to fabricate test sockets and burn-in sockets of various configurations, as well as other semiconductor device components that are currently made by use of molding processes.

The present invention also includes stereolithographic systems that include the object release elements on the platens thereof, methods for stereolithographically fabricating objects by using the object release elements, and the objects that are produced when object release elements that incorporate teachings of the present invention are used in stereolithographic fabrication processes.

Other features and advantages of the present invention will become apparent to those of ordinary skill in the art through consideration of the ensuing description, the accompanying drawings, and the appended claims.

### BRIEF DESCRIPTION OF THE SEVERAL VIEWS OF THE DRAWINGS

In the drawings, which depict exemplary embodiments of various aspects of the present invention:

FIG. 1 schematically depicts an example of a conventional stereolithography process;

FIG. 2 is a side view illustrating the result of a conventional process for facilitating the removal of a stereolithographically fabricated object from the platen on or over which it has been fabricated;

FIG. 3 is a cross-sectional representation of an exemplary object release element that embodies teachings of the present invention and which includes a substantially planar substrate that is formed from a material which is removable from a stereolithographically fabricated object;

FIG. 3A is a cross-sectional representation of an exemplary object release element of the present invention and which includes a lower surface which is configured to be secured to a platen by way of a negative pressure communicated to a support surface of the platen;

FIG. 4 is a cross-sectional representation of another exemplary embodiment of object release element according to the present invention, which includes an object release coating on a substantially planar substrate thereof, the object release coating being formed from a material that is removable from a stereolithographically fabricated object;

FIG. 5 is a cross-sectional representation of an exemplary embodiment of an object release element that includes a nonplanar fabrication surface;

FIG. 6 is a cross-sectional representation of still another exemplary embodiment of object release element, which is configured for use in forming objects that include regions that overhang the object release element and, thus, which protrude from a lower surface an object formed thereon;

FIG. 7 is a schematic representation depicting placement of an object release element of the present invention on a platen of stereolithographic fabrication equipment;

FIGS. 8 through 10 are schematic representations that show stereolithographic fabrication of an object over an object release element that has been secured to the platen of stereolithographic fabrication equipment;

FIGS. 11 and 12 are schematic representations that illustrate exemplary acts that may be effected to remove the object release element from the platen; and

FIGS. 13 and 14 schematically depict removal of the object release element from the object that has been stereolithographically fabricated thereon.

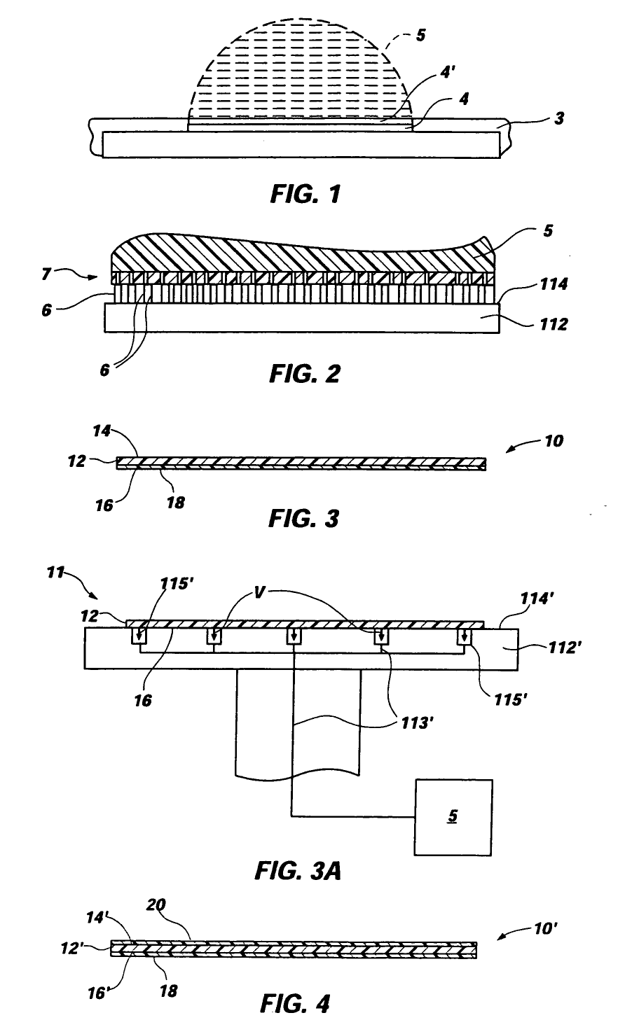

### DETAILED DESCRIPTION OF THE INVENTION

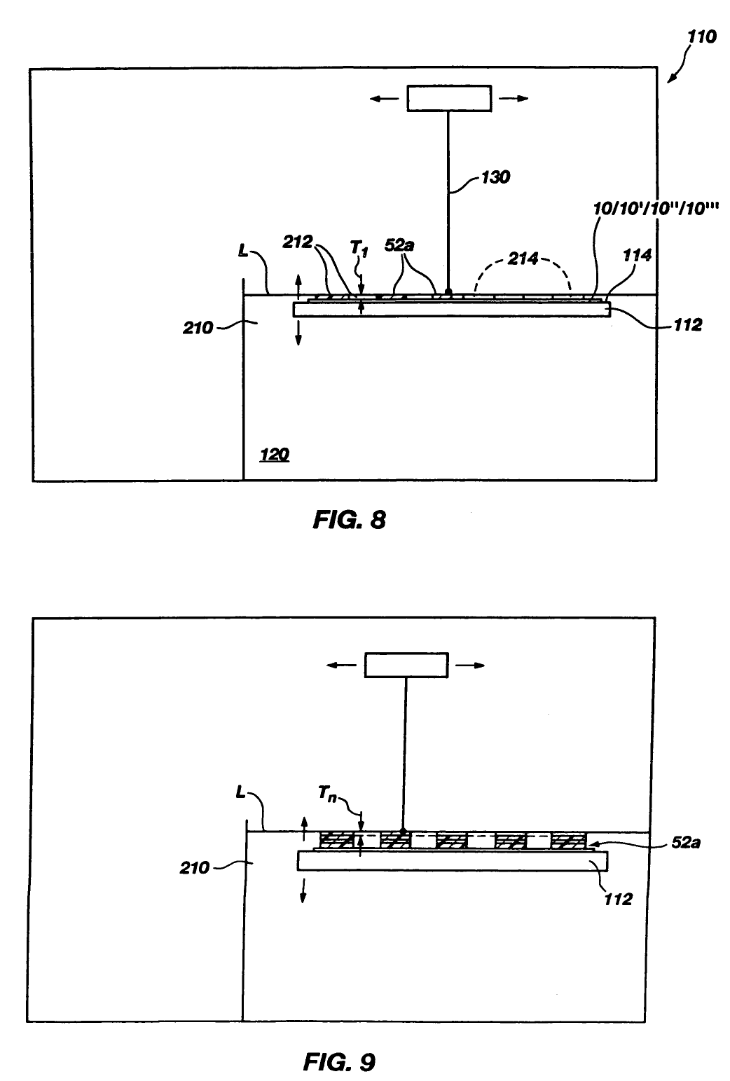

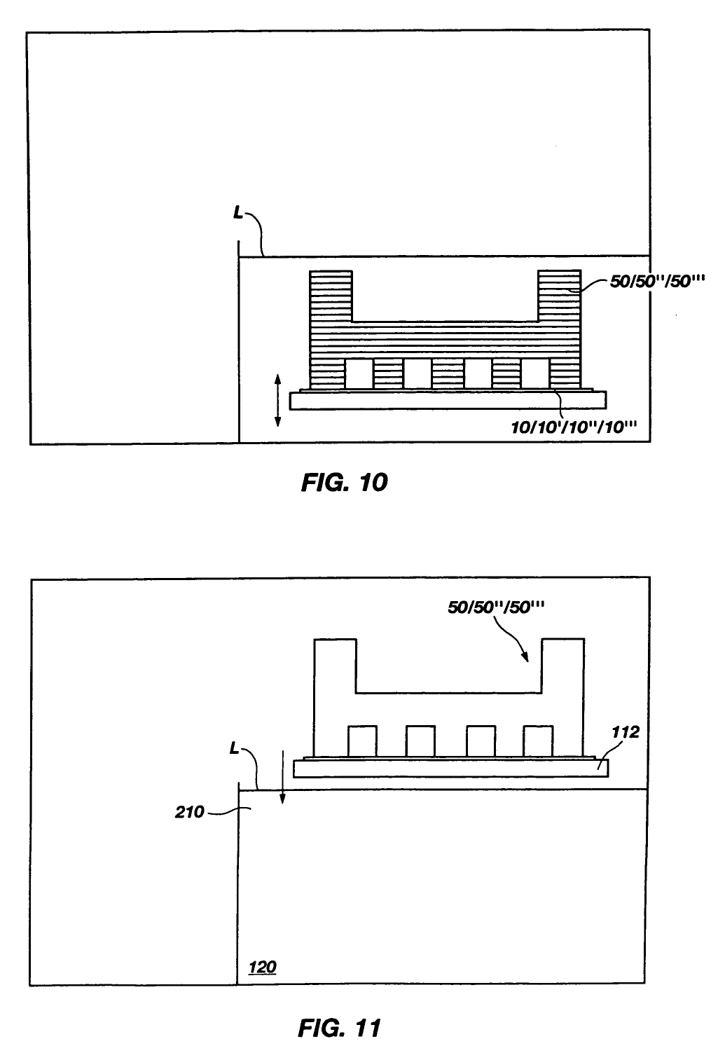

An exemplary embodiment of object release element 10 that incorporates teachings of the present invention is shown in FIG. 3. Object release element 10 includes a substantially planar substrate 12 which has a shape and dimensions that are suitable for placement over at least a portion of a platen 112 of stereolithographic fabrication equipment 110 (FIG. 8) by which one or more objects 50 (FIG. 10) will be formed. In addition, object release element 10 includes an adhesive coating 18 on a lower surface 16 of substantially planar substrate 12, while an upper surface 14 of substantially planar substrate 12 remains exposed.

Substantially planar substrate 12 comprises a material to which selectively consolidated regions of a lowermost layer of an object 50 (FIG. 10) under fabrication will adhere, but which is readily removable therefrom, such as by peeling (i.e., pulling on substantially planar substrate 12 with sufficient force to remove the same from object 50), by etching, as known in the art and as suitable for removing the material of substantially planar substrate 12 without substantially removing or otherwise adversely affecting the material of object 50, or by any other suitable technique.

Examples of materials from which substantially planar substrate 12 may be formed include, but are not limited to, polyethylene (“PE”), polyethyleneteraphthalate (“PET”), and polyethylene ethyl ketone (“PEK”).

Adhesive coating 18 comprises a material which will adhere to a surface of platen 112 of stereolithographic fabrication equipment 110 (FIG. 8) while an object 50 (FIG. 10) is being stereolithographically fabricated thereon, but which may be readily removed from platen 112 once the stereolithographic fabrication of object 50 is complete. By way of example only, a material that is tacky and, thus, adheres to a support surface 114 of platen 112 when in an uncured or partially cured state, but which releases from platen when cured, or cross-linked (e.g., by exposure to a sufficient dosage of ultraviolet (UV) radiation, heat, etc.), may be used as adhesive coating 18. UV-curable materials that have these properties include, without limitation, light-curable adhesives available from 3M Company of St. Paul, Minn., and the adhesives that are currently used on the ICROS® tapes of Mitsui Chemicals America, Inc., of Purchase, N.Y.

FIG. 3A shows an embodiment of object release element 11 that includes a substrate 12 with a lower surface 16 which is configured to be secured to a support surface 114′ of a platen 112′ of a stereolithographic fabrication apparatus (e.g., stereolithographic fabrication apparatus 110 of FIGS. 8 through 12) by way of a negative pressure V (e.g., a vacuum). Thus, object release element 11 may lack the adhesive coating (FIG. 3) of object release element 10. Negative pressure V may be communicated to support surface 114′ from a negative pressure source S through one or more conduits 113′ within or otherwise associated with platen 112′ and ports 115′ that communicate with both conduit 113′ and support surface 114′. Lower surface 16 may merely comprise a substantially planar surface, or substrate 12 may be formed from a material (e.g., a somewhat conformable material) which seals against support surface 114′ as a negative pressure is applied through platen 112′ to lower surface 16.

Another exemplary embodiment of object release element 10′ according to the present invention is shown in FIG. 4. In addition to a substantially planar substrate 12′ and an adhesive coating 18 on a lower surface 16′ of substantially planar substrate 12′, object release element 10′ includes an object release coating 20 on an upper surface 14′ of substantially planar substrate 12′. Object release coating 20 may be formed from a material, such as PE, PET, or PEK, that will adhere to, but is readily removable from, a stereolithographically fabricated object 50 (FIG. 10). As such, substantially planar substrate 12′ may be formed from any suitable material to which an object release coating 20 will adhere, at least until removal of object release element 10′ from an object 50 is desired.

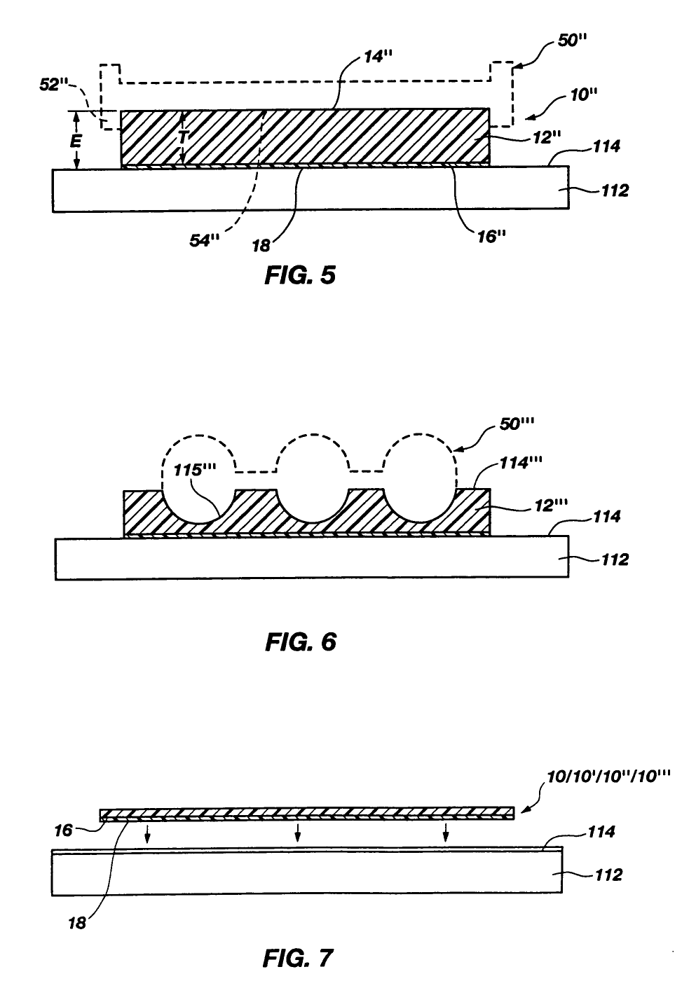

Turning now to FIG. 5, another embodiment of object release element 10″ according to the present invention is depicted. Object release element 10″ includes a substrate 12″, which includes substantially planar, parallel, opposite upper and lower surfaces 14″ and 16″, respectively, and which has a thickness T that is greater than those of substrates 12 and 12′ of object release elements 10 and 10′, respectively (FIGS. 3 and 4, respectively). Accordingly, upper surface 14″ of substrate 12″ of object release element 10″ is elevated above a support surface 114 of a platen 112 upon which object release element 10″ is placed by a distance E which is at least as great as thickness T. As such, object release element 10″ is useful for fabricating one or more objects 50″ that include features 51″ that protrude from a fabrication surface 54″ thereof located over upper surface 14″, or which intersect a plane on which fabrication surface 54″ resides. Accordingly, thickness T of substrate 12″ is about the same dimension as or larger than a distance P that feature 51″ extends beyond lowermost fabrication surface 54″ of object 50″.

Of course, the material from which substrate 12″ is formed may adhere to, but be readily removable from, a stereolithographically fabricated object 50″, or substrate 12″ may include a coating (not shown) of such a material on an upper surface 14″ thereof, as described with respect to object release element 10′, which is depicted in FIG. 4.

In order to facilitate adhesion of object release element 10″ to support surface 114 of platen 112 of stereolithographic fabrication equipment 110 (FIG. 8), an adhesive coating 18, such as that described above in reference to object release elements 10 and 10′ depicted in FIGS. 3 and 4, respectively, may be located on at least a portion of lower surface 16″ of substrate 12″ of object release element 10″.

FIG. 6 illustrates an object release element 10′″ which includes a three-dimensional substrate 12′″. Substrate 12′″ may be formed from a material that will adhere to, but is readily removable from, a stereolithographically fabricated object 50′″, or it may include a coating (not shown) of such material on an upper surface 14′″ thereof, as described with respect to object release element 10′, which is depicted in FIG. 4.

With continued reference to FIG. 6, as lower surface 16′″ of substrate 12′″ is configured to be placed against a support surface 114 of a platen 112 of stereolithographic fabrication equipment 110 (FIG. 8), lower surface 16′″ is substantially planar. Like object release elements 10 and 10′, object release element 10′″ includes an adhesive coating 18 on at least a portion of lower surface 16′″ thereof so that object release element 10′″ may be secured to support surface 114 of platen 112 during stereolithographic fabrication of one or more objects 50′″ thereon and to facilitate ready removal of each object 50′″ from support surface 114 of platen 112 once stereolithographic fabrication processes have been completed.

Upper surface 14′″ of substrate 12′″, against which an object 50′″ is to be fabricated, is, however, nonplanar. The contour of upper surface 14″ may correspond to (i.e., act as a “negative” for) a corresponding bottom surface of each object 50′″ that is to be stereolithographically fabricated on object release element 10′″. As shown in FIG. 6, upper surface 14′″ of substrate 12′″ includes a concave recess 15′″, within which a complementary convex surface 53′″ of an object 50″ may be formed during the stereolithographic fabrication of object 50′″. Of course, upper surfaces 14′″ having other nonplanar configurations, including other configurations of recesses, are also within the scope of the present invention.

Turning now to FIG. 7, placement of an object release element 10, 10′, 10″, 10′″ that incorporates teachings of the present invention onto a platen 112 of stereolithographic fabrication equipment 110 (FIG. 8) is depicted.

Initially, to facilitate removal of object release element 10, 10′, 10″, 10′″ from a support surface 114 of platen 112, support surface 114 may be at least partially formed from a material from which cured adhesive coating 18 may be readily removed, or a “nonstick material.” By way of example only, a nonstick material such as a TEFLON® fluorine-containing polymer available from E.I. du Pont de Nemours & Company of Wilmington, Del., or a fluorine-containing polymer available from another source may be used, employing known processes, to form at least a portion of support surface 114 or a lining or coating thereon.

If support surface 114 does not include a material from which adhesive coating 18 may be readily removed, at least a portion of a support surface 114 of platen 112 may be lined or coated with a layer 116 of nonstick material. By way of example only, layer 116 may be formed on an upper surface 114 of a platen 112 (e.g., a platen that includes stainless steel, quartz, etc.) by using known techniques to vapor deposit a fluorine-containing polymer, such as TEFLON®.

Object release element 10, 10′, 10″, 10′″ is oriented over support surface 114 of platen 112 with lower surface 16 thereof and adhesive coating 18 facing support surface 114. Once object release element 10, 10′, 10″, 10′″ has been positioned over support surface 114 as desired, object release element 10, 10′, 10″, 10′″ may be temporarily secured in position relative to support surface 114 by way of the tackiness of adhesive coating 18. The tackiness of adhesive coating 18 provides sufficient adhesion to support surface 114 or a layer 116 thereon so that object release element 10, 10′, 10″, 10′″ will maintain a stationary position relative to platen 112 as an object 50 (FIG. 10) is being stereolithographically fabricated on object release element 10, 10′, 10″, 10′″.

With returned reference to FIG. 3A, object release element 11 may be secured to platen 112′ by placing object release element 11 on support surface 114′ of platen 112′ and actuating source S such that negative pressure V is applied through conduit 113′ and ports 115′ to lower surface 16 of substrate 12 of object release element 11.

Once object release element 10, 10′, 10″, 10′″ has been secured to support surface 114 of platen 112 or, as shown in FIG. 3A, once object release element 11 has been secured to support surface 114′ of platen 112′, stereolithographic fabrication of one or more objects 50, 50″, 50′″ (FIG. 10) on object release element 10, 10′, 10″, 10′″, or 11 may commence, as known in the art, without the need for conventional preliminary fabrication of hairs or mesas. FIGS. 8 through 10 depict an exemplary process for fabricating an object 50, 50″, 50′″ on an object release element 10, 10′, 10″, 10′″ according to the present invention. Although FIGS. 8 through 10 do not depict the fabrication of an object 50, 50″, 50′″ on object release element 11, the same object fabrication processes described hereinafter may be employed when object release element 11 is used.

As shown in FIG. 8, platen 112, with object release element 10, 10′, 10″, 10′″ secured to upper surface 114 thereof, is lowered into a tank 120 of stereolithographic fabrication equipment 110. Tank 120 is partially filled to a predetermined level L with unconsolidated material 210, such as a photopolymer (e.g., a UV-curable polymer, such as CIBATOOL SL 5170 and SL 5210 resins (for the SLA-250/50HR system), CIBATOOL SL 5530 resin (for the SLA-5000 and SLA-7000 systems), and CIBATOOL SL 7510 resin (for the SLA-7000 system) each of which is available from Ciba Specialty Chemicals Company)). Initially, platen 112 is lowered into unconsolidated material 210 a sufficient distance that a layer 212 of unconsolidated material 210 of desired thickness T₁ is formed over object release element 10, 10′, 10″, 10′″. Focused consolidating energy 130, such as a beam (e.g., a laser beam) of a wavelength or range of wavelengths (e.g., UV radiation) suitable for at least partially consolidating unconsolidated material 210, is then directed onto selected regions 214 of layer 212 to at least partially cure unconsolidated material 210 located in selected regions 214. Of course, the movement of focused consolidating energy 130 may be controlled, such as by way of a controller that operates in accordance with programming for fabricating a first layer 52a of an object 50, 50″, 50′″ (FIG. 10), as known in the art of stereolithography. When first layer 52a is completely formed, platen 112 may again be lowered a sufficient distance to form another layer 52n of unconsolidated material 210 of a corresponding thickness Tₙ over first layer 52a, and the selective consolidation of unconsolidated material within specified regions of that layer effected, over and over again, as shown in FIG. 9, until the stereolithographic fabrication of each object 50, 50″, 50′″ on object release element 10, 10′, 10″, 10′″ is complete, as shown in FIG. 10.

Turning now to FIG. 11, once object 50, 50″, 50′″ is complete, platen 112 may be raised above level L so that unconsolidated material 210 that remains on object 50, 50″, 50′″ and platen 112 may be recovered within tank 120, as known in the art. In this manner, unused unconsolidated material 210 may be preserved for subsequent use.

In addition, either prior to, during, or after the removal of object 50, 50″, 50′″ from tank 120, adhesive coating 18 (FIGS. 3 through 6) of object release element 10, 10′, 10″, 10′″ may be exposed to conditions that will facilitate the removal of object release element 10, 10′, 10″, 10′″ and, thus, object 50, 50″, 50′″ from platen 112.

By way of example only, when a UV-curable material or light-curable material is employed as adhesive coating 18, adhesive coating 18 may be exposed to a sufficient dosage of radiation of one or more appropriate wavelengths to initiate cross-linking, or curing, of the material of adhesive coating 18. Such exposure may be effected until the material of adhesive coating 18 is substantially cross-linked, or cured, or followed with exposure of adhesive coating 18 to other conditions, such as increased temperature, that will facilitate further cross-linking, or curing, thereof.

Alternatively, if a heat-curable material is employed as adhesive coating 18, adhesive coating 18 may heated to a sufficient temperature to cross-link, or cure, the same.

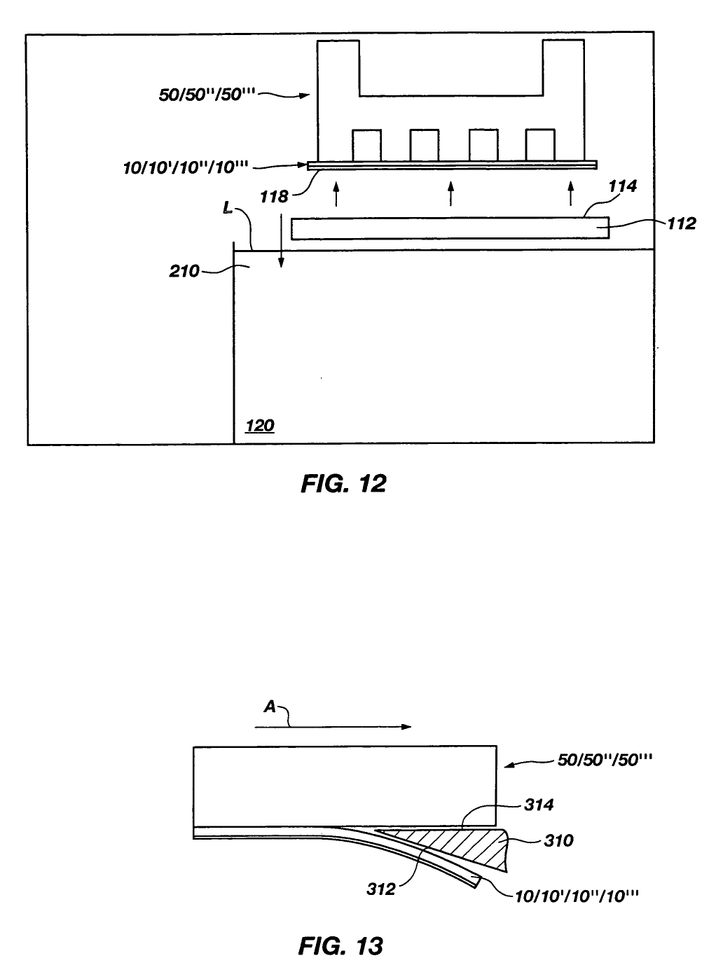

When the material of adhesive coating 18 has been substantially cured, it will no longer adhere to the nonstick material of upper surface 114 of platen 112 or of a nonstick layer 116 thereon. As a result, object release element 10, 10′, 10″, 10′″ and each object 50, 50″, 50′″ carried thereby may be readily removed from upper surface 114 of platen 112, as illustrated in FIG. 12. Additionally, by substantially curing the material of adhesive coating 18, substantially no residual adhesive material will remain on upper surface 114 of platen 112, eliminating the need to clean the same and, thus, the associated potential for damaging upper surface 114.

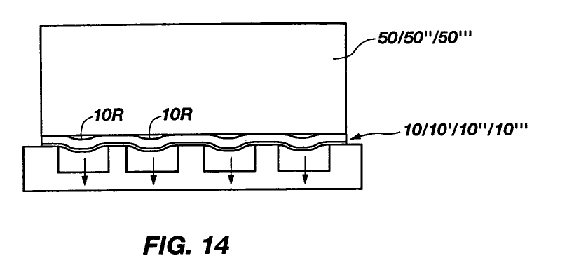

Referring now to FIGS. 13 and 14, exemplary methods for removing object release element 10, 10′, 10″, 10′″ from one or more fabricated objects 50, 50″, 50′″ are depicted.

As shown in FIG. 13, object release element 10, 10′, 10″, 10′″ may be peeled from each object 50, 50″, 50′″ that has been stereolithographically fabricated thereon. As is well known, peeling may be effected by pulling one or both of object release element 10, 10′, 10″, 10′″ and an object 50, 50″, 50′″ thereon away from the other. Such peeling may be effected manually or mechanically. By way of example only, object release element 10, 10′, 10″, 10′″ may be pulled away from one or more objects 50, 50″, 50′″ by placing an edge of object release element 10, 10′, 10″, 10′″ on one side 312 of a separating edge 310 with the majority of each object 50, 50″, 50′″ being located on the opposite side 314 of separating edge 310. A pulling force, exerted substantially along the plane of object release element 10, 10′, 10″, 10′″, as shown by arrow A, is then applied to force object release element 10, 10′, 10″, 10′″ and each object 50, 50″, 50′″ carried thereby onto opposite sides 312 and 314, respectively, of separating edge 310. This process continues until object release element 10, 10′, 10″, 10′″ has been completely removed from each object 50, 50″, 50′″ that was stereolithographically fabricated thereon.

FIG. 14 depicts another exemplary method for removing objects 50, 50″, 50′″ from object release elements 10, 10′, 10″, 10′″. The method depicted in FIG. 14, which employs equipment similar to that described in U.S. Pat. No. 6,202,292, issued to Farnworth et al. on Mar. 20, 2001, the entire disclosure of which is hereby incorporated herein by this reference, includes reducing the adhesion of regions of object release element 10, 10′, 10″, 10′″ to one or more objects 50, 50″, 50′″ thereon by applying negative pressure (e.g., vacuum), shown as arrows V, to regions of at least a portion 10R thereof while an object 50, 50″, 50′″ located opposite that portion of object release element 10, 10′, 10″, 10′″ is maintained in a substantially stationary position. Each object 50, 50″, 50′″ over a region 10R of reduced adhesion may then be removed (e.g., by pulling the same) from object release element 10, 10′, 10″, 10′″ with relative ease, such as by use of a vacuum pick-up head, mechanically, or manually.

Of course, other techniques for removing object release element 10, 10′, 10″, 10′″ from one or more stereolithographically fabricated objects may also be used without departing from the scope of the present invention.

It is currently preferred that the technique that is employed leave substantially no pieces of object release element 10, 10′, 10″, 10′″ or residue therefrom on object 50, 50″, 50′″. It is also currently preferred that little or no additional finishing of the surface 54 of object 50, 50″, 50′″ that was located adjacent to object release element 10, 10′, 10″, 10′″ prior to removing the same from object 50, 50″, 50′″ be required.

Although the foregoing description contains many specifics, these should not be construed as limiting the scope of the present invention, but merely as providing illustrations of some of the presently preferred embodiments. Similarly, other embodiments of the invention may be devised which do not depart from the spirit or scope of the present invention. Moreover, features from different embodiments of the invention may be employed in combination. The scope of the invention is, therefore, indicated and limited only by the appended claims and their legal equivalents, rather than by the foregoing description. All additions, deletions, and modifications to the invention, as disclosed herein, which fall within the meaning and scope of the claims are to be embraced thereby.

What is claimed:

1. A method for fabricating at least one object by programmed material consolidation, comprising:
placing at least one object release element on a platen of programmed material consolidation equipment;
fabricating a first layer of the at least one object directly on the at least one object release element;
fabricating a remainder of the at least one object;
removing the at least one object release element from the platen while leaving substantially no residue on the platen; and
removing the at least one object release element from the at least one object.

2. The method of claim 1, further comprising:
providing a coating comprising a nonstick material on at least a portion of an upper surface of the platen prior to the placing.

3. The method of claim 2, wherein providing comprises providing a coating comprising a fluorine-containing polymer on at least the portion of the upper surface.

4. The method of claim 3, wherein providing comprises vapor depositing the fluorine-containing polymer onto at least the portion of the upper surface.

5. The method of claim 2, wherein placing comprises placing at least one object release element comprising an adhesive coating on the platen.

6. The method of claim 1, wherein placing comprises placing at least one object release element including an adhesive coating comprising an at least partially uncured material.

7. The method of claim 6, wherein removing the at least one object release element from the platen comprises substantially curing the adhesive coating.

8. The method of claim 6, wherein placing comprises placing the at least one object release element with the adhesive coating thereon comprising an at least partially uncured radiation-curable material.

9. The method of claim 8, wherein removing the at least one object release element from the platen comprises exposing the radiation-curable material to at least one wavelength of curing radiation.

10. The method of claim 8, wherein placing comprises placing the at least one object release element with the adhesive coating thereon comprising an at least partially uncured ultraviolet-curable material.

11. The method of claim 10, wherein removing the at least one object release element from the platen comprises exposing the ultraviolet-curable material to ultraviolet radiation.

12. The method of claim 1, wherein placing includes securing the at least one object release element to the platen with a negative pressure.

13. The method of claim 12, wherein removing the at least one object release element from the platen comprises reducing an amount of the negative pressure applied to the at least one object release element.

14. The method of claim 1, wherein placing comprises placing at least one object release element with a surface that includes a material to which at least partially consolidated material adheres while fabricating the first layer and the remainder and which is readily removable from the at least one object after fabricating the remainder.

15. The method of claim 14, wherein placing comprises placing at least one object release element that includes a surface which comprises at least one of polyethylene, polyethyleneteraphthalate, and polyethylene ethyl ketone on the platen.

16. The method of claim 1, wherein at least one of fabricating the first layer and fabricating the remainder of the at least one object comprises selectively exposing unconsolidated material to focused consolidating energy to at least partially consolidate the unconsolidated material.

17. The method of claim 16, wherein selectively exposing comprises selectively exposing uncured photopolymer to at least one wavelength of electromagnetic radiation appropriate for at least partially curing the uncured photopolymer.

18. The method of claim 17, wherein selectively exposing comprises selectively exposing ultraviolet-curable polymer to a beam comprising ultraviolet radiation.

19. The method of claim 1, wherein removing the at least one object release element from the at least one object includes peeling the at least one object release element from the at least one object.

20. The method of claim 1, wherein removing the at least one object release element from the at least one object includes:
reducing adhesion of the at least one object release element from at least one region of a surface of the at least one object; and
pulling the at least one object from the at least one object release element.

21. The method of claim 20, wherein reducing adhesion of the at least one object release element from at least one region of a surface of the at least one object comprises applying a negative pressure to at least a portion of the at least one object release element.

22. A method for removing a fabricated object from a support surface of a platen of programmed material consolidation equipment, comprising:
removing unconsolidated material from at least a portion of the fabricated object;
removing an object release element upon which the fabricated object was formed from a platen without leaving a residue on the platen; and
removing the object release element from the fabricated object.

23. The method of claim 22, wherein removing the object release element upon which the fabricated object was formed from the platen comprises reducing adhesion of the object release element to the platen.

24. The method of claim 23, wherein reducing adhesion comprises substantially curing a quantity of adhesive that secures the object release element to the platen.

25. The method of claim 24, wherein substantially curing comprises exposing a light-curable adhesive between the object release element and the platen to at least one curing wavelength of electromagnetic radiation.

26. The method of claim 25, wherein substantially curing comprises exposing an ultraviolet-curable adhesive between the object release element and the platen to ultraviolet radiation.

27. The method of claim 22, wherein removing the object release element upon which the fabricated object was formed from the platen comprises reducing an amount of negative pressure applied to the object release element through the platen.

28. The method of claim 22, wherein removing the object release element upon which the fabricated object was formed from the platen comprises removing the object release element from the platen while the fabricated object is carried by the object release element.

29. The method of claim 22, wherein the removing the object release element from the fabricated object comprises peeling the object release element from the fabricated object.

30. The method of claim 22, wherein the removing the object release element from the fabricated object comprises:
reducing adhesion of the object release element to the fabricated object; and
pulling the fabricated object off of remaining adherent portions of the object release element.

31. The method of claim 30, wherein the reducing the adhesion of the object release element comprises applying a negative pressure to at least a region of at least a portion of the object release element.

32. A method for fabricating at least one object by programmed material consolidation, comprising:
placing at least one object release element comprising at least one of polyethylene, polyethyleneteraphthalate, and polyethylene ethyl ketone on the platen on a platen of programmed material consolidation equipment;
fabricating at least one object on the on the at least one object release element, the at least one object being temporarily adhered to the at least one object release element;
removing the at least one object release element from the platen while leaving substantially no residue on the platen; and
removing the at least one object release element from the at least one object.

33. The method of claim 32, wherein placing the at least one object release element comprises placing the at least one object release element on a platen comprising a non-stick surface.

34. The method of claim 33, wherein placing the at least one object release element comprises adhesively securing the at least one object release element to the non-stick surface of the platen.

35. The method of claim 32, wherein placing the at least one object release element comprises securing the at least one object release element to the platen with an adhesive material that prior to curing adheres to the platen and after curing may be more easily removed from the platen.

36. The method of claim 32, further comprising:
applying a negative pressure through the platen to a surface of the at least one object release element to secure the object release element to the platen.
